(19) United States
(12) Patent Application Publication
(10) Pub. No.: US 2011/0016964 A1
(43) Pub. Date: Jan. 27, 2011

(54) Device for Registration of Rotational Parameters During Assembly of a Pipe String

(76) Inventor: Alf Terje Strom, Hundvag (NO)

Correspondence Address: BOHAN MATHERS, PO BOX 17707, PORTLAND, ME, 04112-8707, US

(21) Appl. No.: 12/936,002

(22) PCT Filed: Mar. 16, 2009
(86) PCT No.: PCT/NO09/00095

§ 371 Date: Oct. 1, 2010

(30) Foreign Application Priority Data
Apr. 3, 2008 (NO) 20081650

(51) Int. Cl. E21B 47/16; G01N 21/35

(52) U.S. Cl. 73/152.59; 356/51

(57) ABSTRACT

Disclosed is a measuring sensor unit for registering one or more rotational parameters of forces that are exerted on a pipe string as it is being rotated into a well by a drilling machine. The measuring sensor unit has a body with a first end portion that is constructed to releasably engage with the end of a drilling machine drive shaft and a second end portion constructed to releasably engage with the end of a pipe string or with a tool that is integrated into a pipe string. Sensors are mounted on the measuring sensor unit and are in wireless communication with a signal transmitter. The sensors register one or more rotational parameters relevant for the rotation of the pipe string.

### BACKGROUND INFORMATION

1. Field of the Invention

The invention relates to a device for registration of rotational parameters during assembly of a pipe string, more particularly a section comprising sensors and communication means provided for interconnection with a top drive and a pipe string.

2. Description of the Prior Art

During rotation of a pipe string extending down into a borehole, such as a drill string or casing extending down into a wellbore in an oil or gas field, there is a need for continuous monitoring of rotational parameters like the pipe string rotational speed, and torque applied to the pipe string.

It is known from prior art to measure the torque applied to the pipe string by collecting information from the units in use, for example, from a top drive and any other units being used in assembly and disassembly of the pipe string, such as a joining tool (power tong) with means for clamping and rotation of at least parts of the pipe string. Examples of the type of information used includes input power to a motor in the form of power consumption, hydraulic oil pressure or oil flow rate. Rotational speed may be registered by using an inductive sensor attached to a rotating element, such as a gear, in the driving unit.

One of the drawbacks of the prior art is that electrical or hydraulic power is supplied to the indicator device for applied torque. This may result in large deviations between calculated and actual torque when the motor power is shut down, because the moment of inertia for rotating components influences the actual torque, whereas the calculated torque falls to zero when the motor power is disconnected.

Another drawback in prior art is the necessity to connect the measuring equipment to the units from which parameters are being collected. This requires physical access to relevant details, and signal-carrying leads must be drawn between sensors and signal conditioning units, and possibly to a wireless signal transmitter. Replacement of components in a drive unit may require the installation of new measuring equipment, or at least require that the equipment be re-calibrated. This is the case, for example, when a drilling machine motor has to be renewed.

The calibration in itself represents another drawback in prior art. Calibration is, technically speaking, a comprehensive and time consuming operation, and need to be carried out on the operational drilling equipment. This naturally hampers the drilling operation and influences productivity. The calibration must be done with the relevant drilling machine embodiment, and renewal of components in this case, and also during normal maintenance, might require repeated calibration.

Another drawback in the prior art is the presence of wires connected with signal communication and calibration, which pass through the area through which hanging pipe stands are moved in conjunction with assembly and disassembly of the pipe string. Such cabling can easily hamper the work or result in damage to wires and other equipment.

US2007/251701 A1 discloses a torque measuring unit for use with a top drive. A method for connecting threaded tubular members for use in a wellbore is disclosed. The method includes operating a top drive, thereby rotating a first threaded tubular member relative to a second threaded tubular member, measuring a torque exerted on the first tubular member by the top drive, wherein the torque is measured using a torque shaft rotationally coupled to the top drive and the first tubular member. A strain gauge is mounted on the torque shaft. The measured torque is wirelessly transmitted from the torque shaft to a stationary interface surrounding the torque shaft. A turns gear is coupled to the torque shaft. A proximity sensor, useful for the monitoring of the rotation of the first tubular member, is mounted in the interface. Thus the interface and the rotation sensor stand still linked to adjacent structures. The interface also houses an AC power supply which supplies power to the strain gauge by induction interaction between a primary coil of the interface and a secondary coil of the torque shaft.

U.S. Pat. No. 3,929,009 discloses the use of orthogonal pairs of strain gauges inside symmetrical cavities provided on the cylindrical bottom sections of a so-called Kelly. A groove on the outside forms a cable path connecting the strain gauge cavities and a transmission system located at the upper end of the Kelly. There is no teaching of either the use of rotational sensing devices or the use of wireless signal communication.

### BRIEF SUMMARY OF THE INVENTION

The object of the invention is to remedy or reduce at least one of the prior art drawbacks.

The object is achieved by features stated in the following description and in the claims.

The invention relates to a device that registers rotational parameters during the assembly of a pipe string. All sensors are provided in a unit that is connected to a top drive output shaft by means of a releasable connection. In the operative state, the unit is placed between the top drive shaft and the pipe string and rotates with the drive shaft and the pipe string. All signal communication is wireless to a signal receiver that is used to the drilling machine. Because all sensors are built into a releasable unit, calibration and other maintenance may be carried out in a location remote from that of the drilling machine.

The invention relates more particularly to a measuring sensor unit comprising a first end portion constructed to be in releasable engagement with a drive shaft of a top drive drilling machine and also a second end portion constructed to be in releasable engagement with a first pipe string end portion or with a tool integrated into the pipe string integrated for releasable engagement with the first pipe string end portion. The sensors are mounted on the body of the measuring sensor unit, which, in this case is a tubular stem, and are in wireless signal communication with a signal-receiver. The measuring sensor unit is mounted, so as to be able to rotate together with the drive shaft and the first pipe string end portion or the tool that is integrated into the pipe string. Each of the sensors is connected to at least one signal transmitter that is capable of wireless communication with a signal receiver remote from the measuring sensor unit.

A first sensor is mounted so as to be able to register changes in axial torsion forces transferred between the drilling machine drive shaft and the pipe string. A second sensor is one from a group of sensors that includes accelerometer, gyroscope, GPS, and electronic compass. The first sensor may be affixed to a circumferential surface on a stem in the measuring sensor unit. The circumferential surface is preferably provided in the bottom of a groove surrounding the stem. An example of the type of sensor for the first sensor is a strain gauge. The second sensor may be arranged to register a rotational movement of the measuring sensor unit about a pipe central axis.

A housing may surround a portion of the measuring sensor unit and accommodate the first sensor. The signal transmitter may be provided in a transmitter housing that is connected to the measuring sensor unit. The second sensor may also be provided in the housing surrounding a portion of the measuring sensor unit, or in the transmitter housing that is connected to the measuring sensor unit.

Wireless signal communication between the signal transmitter and the signal receiver may be by means of infrared light or radio waves.

### BRIEF DESCRIPTION OF THE DRAWINGS

The following figures illustrate a preferred embodiment of the device according to the invention.

FIG. 1 is a schematic illustration of the drilling machine arrangement with a measuring sensor unit according to the invention mounted between the drilling machine and the pipe string.

FIG. 2 is a detail view of the measuring sensor unit according to the invention.

FIG. 3 is a cross-sectional view of the measuring sensor unit as shown in FIG. 2.

### DETAILED DESCRIPTION OF THE INVENTION

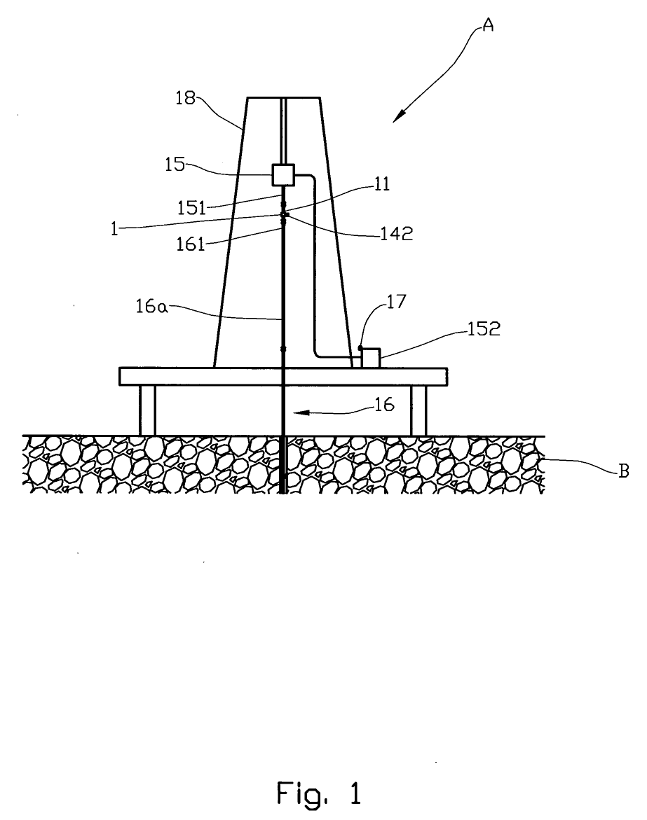

FIG. 1 illustrates an arrangement A of a conventional drilling machine. As shown, a top drive 15 is movably suspended in a derrick 18. The top drive 15 serves to rotate a pipe string 16 in a borehole that extends into an underground formation B.

The top drive 15 is provided with a downwards extending drive shaft 151 equipped with means for releasable connection to a first end portion 161 of a conventional pipe string 16. The releasable connection includes an external threaded portion on the drive shaft 151 and a corresponding internal threaded portion on the pipe string 16 end portion 161. The pipe string 16 is built up of a series of pipe sections 16A.

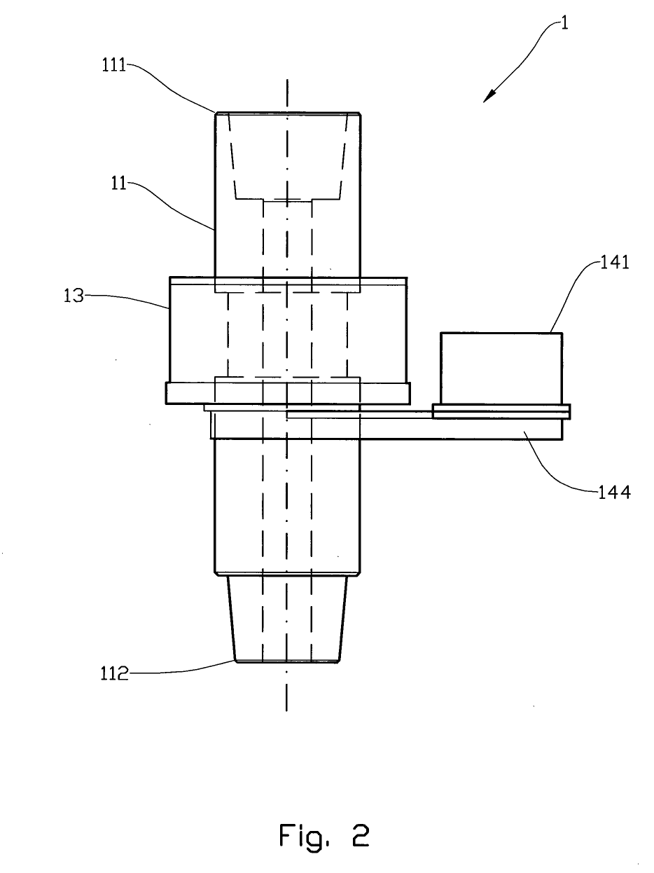

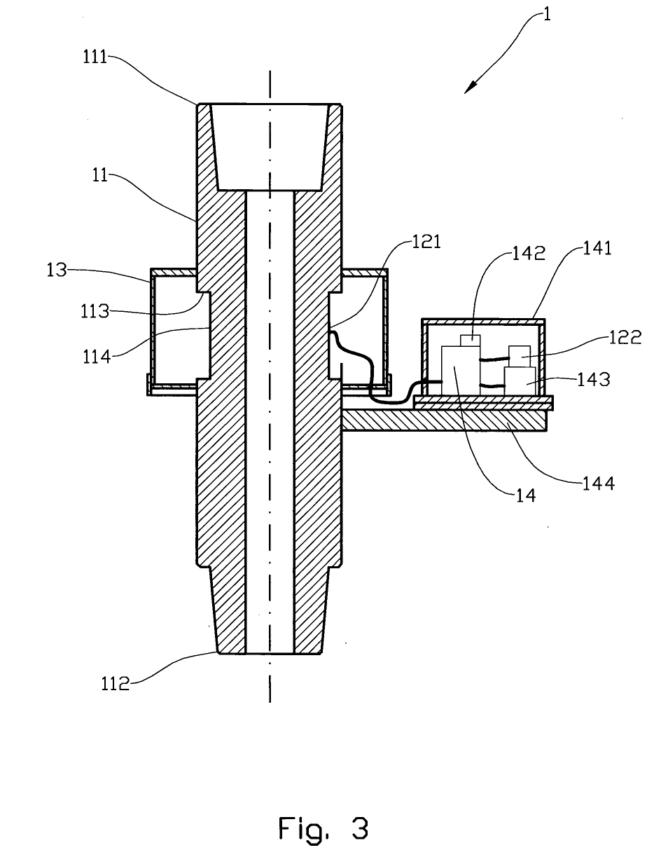

FIGS. 2 and 3 illustrate a measuring sensor unit 1 according to the invention. The measuring sensor unit 1 is provided with a body 11 having a first end portion 111. The body 11 is constructed as a tubular stem and the first end portion 111 has a shape that corresponds to the shape of the pipe string's 16 first end portion 161 and is thereby a mating part to the free end portion of the drive shaft 151. Similarly, the body or stem 11 is provided with a second end portion 112 that corresponds in shape to the drive shaft's 151 end portion and is thereby a mating part to the pipe string 16 first end portion 161. The measuring sensor unit 1 may thereby be releasably fitted between the top drive 15 and the pipe string 16.

The stem 1 has a middle portion defined by a groove 113 that encircles the stem 1, thereby forming a cylindrical circumferential surface 114.

A first sensor 121, which is a deformation-sensing sensor, such as a pair of cross-laid strain gauges, is attached to the circumferential surface 114 and connected to a signal conditioner 14 in a signal communicating way. The purpose of the first sensor 121 is to determine the magnitude of a torque being transferred through the stem 11 from the top drive 15 to the pipe string 16 and to transmit a corresponding signal to the signal conditioner 14.

A second sensor 122, such as a motion sensor, is mounted on the stem 11, so as to measure the rotation of the stem 11 about its central axis, and is connected to the signal conditioner 14 in a signal communicating way.

A sensor housing 13 surrounds the groove 113 and encloses the sensors 121, 122 and protects the groove 113 and the sensors 121, 122, at least partly, against external influences from rain, snow, hail, liquid splashing, wave splashing, etc. The sensor housing 13 is releasably attached to the stem 11, so as to provide access to the groove 113 and the sensors 121, 122 for inspection and maintenance.

The signal conditioner 14 is provided on a console 144 that is mounted on the stem 11. The signal conditioner 14 comprises conventional signal processing means (not shown) for registration and wireless transmission of sensor signals via a sensor transmitter 17 that is provided in connection with a drilling machine control unit 152. The signal conditioner 14 is also connected to an energy source 143 in the form of an electric accumulator. The signal conditioner 14 is also provided with means for registering relevant parameters for the energy source 143, such as voltage and remaining energy reserve, and for transmission of these to the drilling machine control unit 152. A transmitter housing 141 protects the signal conditioner 14, the signal transmitter 142, and the energy source 143, at least partly, against external influences from rain, snow, hail, liquid splashing, wave splashing, etc.

Before the measuring sensor unit 1 is put to use in ordinary operations, it is made ready by charging the energy source 143 and calibrating the sensors 121, 122. Calibration of the first sensor 121 may be done by fastening the sensor 121 to the second end portion 112 of the measuring sensor unit 1 and applying a known torque to the first end portion 111. The read sensor signal values are compared in a per se known way with the known torque to establish conversion formulas.

The second sensor 122 is calibrated by coupling the measuring sensor unit 1 to a drive unit (not shown) which can rotate the measuring sensor unit 1 about its central axis at a known speed. The signal values from the second sensor 122 are then compared to the known speed value. Any adjustments or correction factors may then be incorporated in the conditioning of the signal values from the second sensor 122.

The preceding description also shows that the measuring sensor unit 1 is also useful for testing equipment that is used in assembly and disassembly of a pipe string 16, such as a power tong (not shown). Such testing may be carried out, for example, by attaching the second end portion 112 of the measuring sensor unit 1 to a back-up tong (not shown), and attaching the first end portion 111 to the power tong. The power tong is then operated as if in an assembling or disconnecting operation. The actual torque applied to the stem 11 of the measuring sensor unit 1 may then be read from signals generated from the first sensor 121 and compared to the settings available for the power tong.

Even if not shown in the drawings, a person of skill in the art will understand, that the pipe string 16 may comprise one or more tool sections (not shown) which are integrated into the pipe string 16 in the same manner as the pipe stands are assembled, and that, in a given phase of assembly or disassembly of the pipe string 16, the tool sections may also be interconnected with the drive shaft 151 of the drilling machine 15 via the measuring sensor unit 1.

1-10. (canceled)

11. A measuring sensor unit for use on a pipe string or on a tool that is integrated into a pipe string, the pipe string being rotatable by a drilling machine having a top drive and drive shaft suspended in a derrick, so as to drive the pipe string into a well, the measuring sensor unit comprising:
a body that includes a first end portion and a second end portion, wherein the first end portion of the body is constructed so as to releasably engage with a drive shaft of the top drive of the drilling machine and the second end portion is constructed so as to releasably engage with a first end portion of the pipe string, so that the body rotates together with the drive shaft and the pipe string; and
a plurality of sensors mounted on the body for registering parameters of rotational forces exerted on body by the drilling machine, wherein the sensors are connected to at least one signal transmitter and are in wireless signal communication via the signal transmitter with a signal receiver that is remote from the body;
wherein the plurality of sensors includes a first sensor that is constructed and mounted on the body so as to register changes in axial torsion forces transferred from the drive shaft of the drilling machine to the pipe string, and further includes a second sensor that is a sensor from a group of sensors that includes accelerometers, gyroscopes, GPS receivers, and electronic compasses.

12. The measuring sensor unit of claim 11, wherein the first sensor is mounted on the body, so as to register deformation of a circumferential surface on the body.

13. The measuring sensor unit of claim 12, wherein the first sensor is mounted on a circumferential surface on the body of the measuring sensor unit.

14. The measuring sensor unit of claim 13, wherein the body has a circumferential groove defined by a recessed wall and the first sensor is mounted on the recessed wall groove.

15. The measuring sensor unit of claim 11, wherein the first sensor is a strain gauge.

16. The measuring sensor unit of claim 11, wherein the second sensor is mounted so as to register rotational motion of the body about a central axis.

17. The measuring sensor unit of claim 11 further comprising a housing that surrounds a portion of the body and also encloses the first sensor.

18. The measuring sensor unit of claim 11, wherein the signal transmitter is enclosed in a transmitter housing that is connected to the body.

19. The measuring sensor unit of claim 17, wherein the second sensor is enclosed in the housing that surrounds a portion of the body.

20. The measuring sensor unit of claim 17 further comprising a transmitter housing that is attached to the body of the measuring sensor unit, wherein the second sensor is mounted within the transmitter housing.

21. The measuring sensor unit of claim 12, wherein the wireless communication is achieved by means of infrared light.

22. The measuring sensor unit of claim 12, wherein the wireless communication is achieved by means of radio waves.
